(19) United States
(12) Patent Application Publication
(10) Pub. No.: US 2009/0273855 A1
(43) Pub. Date: Nov. 5, 2009

(54) Method for measuring pole width of a slider of a disk drive device

(75) Inventors: Na He, Dongguan City (CN); Xinjian Cheng, Dongguan City (CN); Yu Li, Dongguan City (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 12/149,527

(22) Filed: May 2, 2008

(51) Int. Cl. G11B 27/36

(52) U.S. Cl. 360/31

(57) ABSTRACT

A method for measuring pole width of a slider of a disk drive includes steps of: getting an original image of the pole surface; calculating the light intensity distribution profile of the original image and determining maximum and minimum light intensity data points of the profile; setting average of the maximum and minimum light intensity data points as a threshold; carrying out quadratic differentiation of the profile to obtain a quadratic differential asymptote; determining cross points between the quadratic differential asymptote and the threshold; calculating the distance between the cross points to obtain an initial pole width; and performing data compensation to the initial pole width to obtain a compensated pole width. The method may also measure the distance between edges of other micro-objects.

### FIELD OF THE INVENTION

The present invention relates to a method for detecting edges of a micro-object, particularly to a method for detecting edges of a micro-object using image edge detection technology, and more particularly, to a method for measuring pole width of a slider of an information storage device such as a hard disk drive device using above technology.

### BACKGROUND OF THE INVENTION

Disk drive devices are well known information storage devices. FIG. 1a illustrates a disk drive 200 which includes a magnetic disk 201 rotating at a high speed and a head gimble assembly (HGA) 100 with a slider 203. The slider 203 incorporates a read/write element therein. Radial movement of the HGA 100 over the magnetic disk 201 enables the slider 203 to move from track to track across the surface of the magnetic disk 201 so as to read data from or write data to the magnetic disk 201 by its read/write element.

FIG. 1b is a perspective view of the slider 203 of FIG. 1a viewed from bottom. A magnetic read/write element 216 is formed on one side surface of the slider 203 for achieving data reading/writing operation of the slider relative to the disk 201. The slider 203 also has an air bearing surface (ABS) 217 facing the disk 201. When the disk drive is in operation, an aerodynamic interaction is generated between the ABS 217 and the spinning disk 201 such that the slider 203 is lifted dynamically over the disk 201, thus realizing data read/write operation.

FIG. 1c illustrates an enlarged structure of the magnetic read/write element of the slider shown in FIG. 1b. The magnetic read/write element 216 is formed on the side surface of the slider 203 by deposition of several functional material layers such as magneto-conductive material and electric conductive material on the side surface. The magnetic read/write element 216 includes a read element 226 (generally a magneto-resistance element) and associated circuitry (not shown) for performing data reading operation, and a write element for performing data writing operation. The write element mainly includes a coil 228, a first inductive write pole 221, a second inductive write pole 220 opposite to the first inductive write pole 221 and associated circuitry (not shown). When writing data into the disk, an electric current is generated inside the coil 228, and the electric current then generates a magnetic field such that the inductive write poles 221 and 220 are magnetized by the magnetic field, thus causing magnetization of corresponding tracks on the disk and finally making data recorded into the disk.

The first inductive write pole 221 has a certain width generally called pole width. The dimension accuracy of the pole width W plays an important role in achieving accurate data writing operation, since higher dimension accuracy results in less data writing error. The above dimension accuracy is obtained by comparing the measured pole width value with designed pole width value. In related field, width measurement of an actual pole is implemented by using image edge detecting method. Now, a brief description of a conventional method of detecting pole width is presented below.

As shown in FIG. 2, the conventional method of detecting pole width comprises the following steps: getting an original image of a surface of an object (pole) to be measured (Step 301); calculating the light intensity distribution profile of the original image and determining the maximum and minimum light intensity data points of the profile (Step 302); setting average of the maximum and minimum light intensity data points as a threshold (Step 303); determining the light intensity data at intersection points between the threshold and the profile (Step 304); carrying out quadratic differentiation of the light intensity data at the intersection points to obtain a quadratic differential asymptote (Step 305); determining cross points between the quadratic differential asymptote and the threshold (Step 306); calculating the distance between the cross points to obtain the distance between two edges (Step 307). FIGS. 3a-3b illustrate partial steps of the above-mentioned method. As is shown, the bell-like curve 342 represents the light intensity distribution profile of the original image. Two vertical and parallel lines 341 represent the edge positions of the pole in ideal condition. A threshold line 343 lies between the maximum light intensity data point 344 and the minimum light intensity data point 345, and the light intensity at the threshold line 343 is the average of those at the maximum and minimum light intensity data points. In addition, the threshold line 343 intersects the bell-like curve 342 at two inspection points (intersection-points) 346.

In above-mentioned method, the original image is obtained by utilization of an optical lens system with a high magnification. However, the original image (enlarged image) actually obtained is distorted somewhat with respect to the ideal image because of diffraction during light transmission process. The distortion decreases measuring accuracy. The reason why the accuracy is decreased is analyzed below by explaining the diffraction phenomenon.

FIG. 4a illustrates diffraction phenomenon of the light. As is shown, when a light source 301 travels through a narrow gap 303 defined in a barrier 302, a light belt will occur on a screen behind the barrier 302. When the narrow gap 303 is narrowed, the width of the light belt decreases too. When the narrow gap 303 is narrowed to an extreme size (equivalent to wavelength of the light), the light deviates obviously from its straight line direction and projects on a quite wide area of the screen after the light travels through the narrow gap 303. Simultaneously, bright and dark strips emerge alternatively on the screen, and edges of the strips become fuzzy. FIG. 4b shows an optical lens system in ideal condition. Assuming the optical lens system is free of aberration, a point image formed by transmission of a point light source through the lens system will be of the same size as the point light source. However, due to inevitable manufacture tolerance of the optical lens system, as well as existence of diffraction, the true image formed by light transmission through the lens is diffraction speckle other than a point image. Similarly, an original image of a plane light source (e.g. pole width) formed by light transmission through the lens can be considered as an aggregation of countless diffraction speckles. Therefore, impact of diffraction phenomenon on the measurement accuracy can be understood by mathematical analysis of the diffraction speckles.

Here, the diffraction speckle (also called Airy disk) is expressed as a point spread function

$$h ( {x}_{i} ) = {[ 2 \frac{{J}_{1} \vert π ( {x}_{i} / {r}_{0} ) \vert}{\vert π ( {x}_{i} / {r}_{0} ) \vert} ]}^{2} ,$$

wherein J₁ denotes the first kind of Bessel function, and

$${r}_{0} = \frac{λ {d}_{i}}{a} ,$$

in which dᵢ denotes the distance from the lens to the image plane, and a denotes the diameter of the lens. In order to facilitate measurement, deep ultraviolet light with a wavelength λ of 248 nm and NA (Numerical Aperture) of 0.9 is used as the light source. In this instance,

$${r}_{0} = \frac{λ}{2 NA} = 138 nm ( focus plane ) .$$

By observing the function h(xᵢ), it can be found that when xᵢ=0, t a obvious change point occurs on the figure of the function, and when xᵢ>r=1.22r₀=168 nm (r denotes the radius of the Airy disk), the function has a value zero.

According to optics theory, approaching of two Airy disks will cause their centers overlap with each other. As for the pole width detection system, if the Airy disks overlap to a larger extent, the measured pole width will be smaller and the measured result will deviate from the true value. The data deviation will be derived from algorithms deduction below. The light intensity distribution profile of the pole width is affected by the aggregation of countless diffraction speckles. Here, every diffraction speckle is assumed to take the form of an Airy disk, and therefore, the light intensity distribution profile can be deemed as the aggregation of countless Airy disks overlapped each other.

The overlapping of the Airy disks is implemented by convolving all the Airy disks (namely the point spread function). After convolution of the Airy disks, the light intensity of the pole width at its edges and peak can be expressed as the follow:

The light intensity of the left edge: I_{left}=∫_{-∞}⁰I₀(xᵢ)h(xᵢ)dxᵢ

The light intensity of the right edge: I_{right}=∫₀^{+∞}I₀(xᵢ)h(xᵢ)dxᵢ

The light intensity of the peak: Iₚₑₐₖ=∫_{-∞}^{+∞}I₀(xᵢ)h(xᵢ)dxᵢ

=∫_{-∞}⁰I₀(xᵢ)h(xᵢ)dxᵢ+∫₀^{+∞}I₀(xᵢ)h(xᵢ)dxᵢ

Wherein Iₚₑₐₖ=I_{right}+I_{left}

Due to asymmetry of actually formed Airy disks, when the pole width is very small, only part of the Airy disks overlaps with each other, and in this situation, Iₚₑₐₖ is neither equal to 2 I_{right} nor 2 I_{left}, but is much bigger than 2 I_{right} or 2 I_{left}. Accordingly, for a conventional method, it is inaccurate to set locations where the light intensity is half of the peak value as the threshold line so as to determine the two edges of the pole, since the edge light intensity actually obtained is not half of the peak value due to impact of light diffraction. This scenario can be seen from FIGS. 4c-4d. FIG. 4c shows a curve illustrating impact of diffraction on edges of an ideal pole when the pole width is 2r (r denotes the radius of the Airy disk). The light intensity distribution curve 318 obtained by convolving the Airy disks intersects the ideal edges 314 at cross points 312 and 316. The light intensity at the two cross points 312, 316 is larger than half value of the peak light intensity, or in other words, if the half of the peak light intensity is set as the threshold line, the two cross points between the threshold line and the light intensity distribution curve 318 will be out of the above-mentioned cross points 312 and 316. That is, the pole width value (distance between two cross points formed by intersection of the threshold line and the light intensity distribution curve) measured using the conventional method will be seriously deviated from its ideal value. FIG. 4d shows a curve illustrating impact of diffraction on edges of an ideal pole when the pole width is less than 2r. Similarly, the light intensity at cross points (as shown by arrows A and B in FIG. 4d) formed between the light intensity distribution curve 313 and the ideal pole edges 311 is bigger than half value of the peak light intensity, meaning that locations at which the light intensity is half of the peak light intensity on the light intensity distribution curve 313 are not the true locations of the pole edges.

Hence, it is desired to provide an improved edge detection method for increasing the measure accuracy of the pole width.

### SUMMARY OF THE INVENTION

An object of the present invention is to provide a method for detecting edges of a micro-object, which eliminates or at least decreases the influence of diffraction phenomenon on edge detection process and, in turn, improves edge detection accuracy.

To achieve the above-mentioned object, the present invention provides a method for measuring pole width of a slider, which includes steps of: (1) getting an original image of a surface of the pole; (2) calculating the light intensity distribution profile of the original image and determining the maximum and minimum light intensity data points of the profile; (3) setting average of the maximum and minimum light intensity data points as a threshold; (4) carrying out quadratic differentiation of the profile to obtain a quadratic differential asymptote;(5) determining cross points between the quadratic differential asymptote and the threshold; (6) calculating the distance between the cross points to obtain an initial pole width; and (7) performing data compensation to the initial pole width to obtain a compensated pole width.

In one embodiment of the present invention, the step (7) includes the following steps: (71) providing a compensation database containing a set of predetermined pole width data and a set of compensation data corresponding to the set of predetermined pole width data; (72) inputting the initial pole width data into the compensation database; and (73) comparing the initial pole width data with the predetermined pole width data, if the data is identical, then performing step (74a): adding the predetermined pole width data to the corresponding compensation data so as to obtain compensated pole width; and if the data is different, then performing step (74b): adding the predetermined pole width data which is closest to the initial pole width data to the corresponding compensation data so as to obtain the compensated pole width. The compensation data corresponding to the predetermined edge distance data is negative data.

The step (1) includes: (a) getting a magnified image of the pole surface by an optical microscope system; and (b) capturing the magnified image by a charge coupled device camera. The optical microscope system includes two sets of lens microscope system. The optical microscope system can use any suitable light source. Preferably, the light source is deep ultraviolet with a wavelength of 248 nm.

In comparison with the conventional method, because the method of the present invention compensates the initial pole width, the influence on the measuring result caused by the diffraction is eliminated or reduced, thereby the measure accuracy of the pole width is improved.

The present invention also provides a method for measuring the distance between edges of a micro-object which includes the following steps: (1) getting an original image of a surface of the micro-object; (2) processing the original image to obtain an initial edge distance; and (3) performing data compensation to the initial edge distance to obtain a compensated edge distance.

The present invention will be apparent to those skilled in the art by reading the following description of several particular embodiments thereof with reference to the attached drawings.

### BRIEF DESCRIPTION OF THE DRAWINGS

FIG. 1a is a perspective view of a typical disk drive device;

FIG. 1b is a perspective view of a slider of the disk drive device shown in FIG. 1a;

FIG. 1c is an enlarged perspective view of the pole tip region of the slider shown in FIG. 1b;

FIG. 2 is a flow chart of a conventional method for measuring pole width;

FIGS. 3a-3b illustrate partial steps of the method shown in FIG. 2;

FIG. 4a illustrates light diffraction phenomenon during light travel process;

FIG. 4b is a schematic view of a single lens imaging system;

FIGS. 4c-4d illustrate interference of diffraction phenomenon on micro-object edge detection method of FIG. 2;

FIG. 5a is a flow chart of a method for measuring pole width according to an embodiment of the present invention;

FIG. 5b is a schematic view of a measuring device which performs the method shown in FIG. 5a;

FIG. 6 is a flow chart illustrating detailed steps of data compensation in the method shown in FIG. 5;

FIG. 7a illustrates correlation curves of pole widths simulated by methods of the present invention and prior art with respect to ideal pole widths respectively;

FIG. 7b is an enlarged view of low end portions of the correlation curves shown in FIG. 7a;

FIG. 8 shows correlation curves between pole widths achieved by DUV (deep ultraviolet device) and SEM (scanning electric microscope) before and after pole width compensation process.

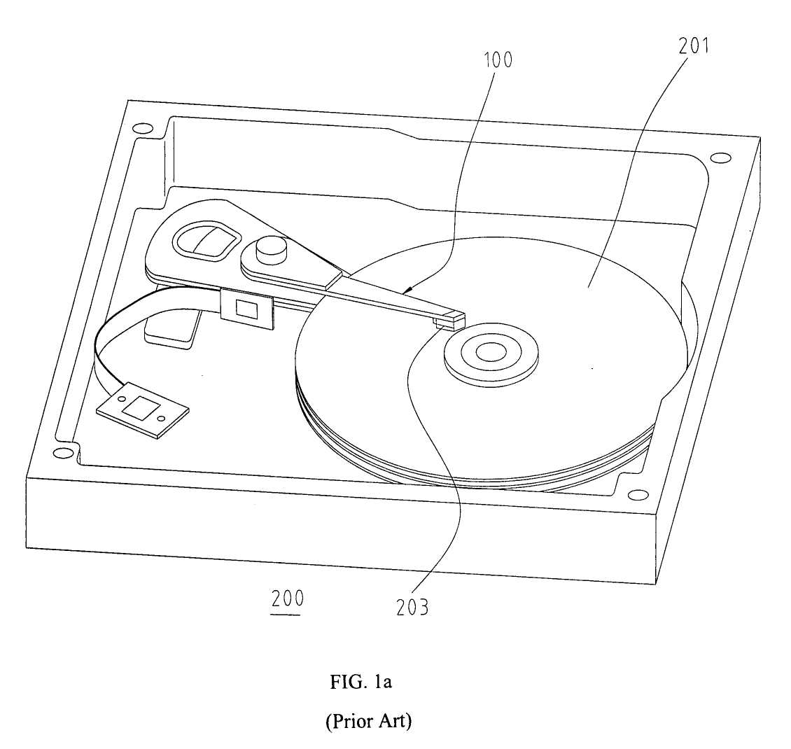

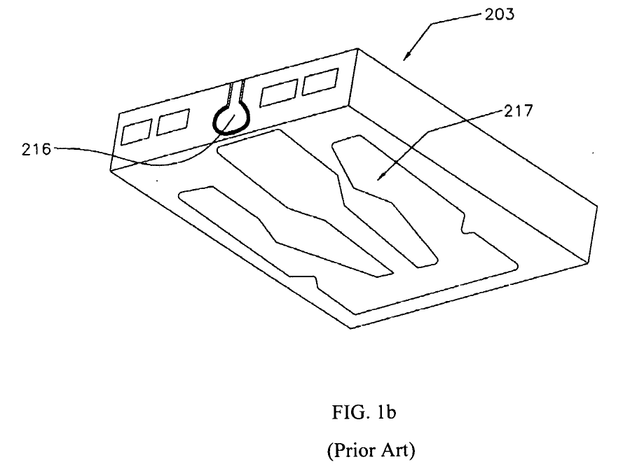

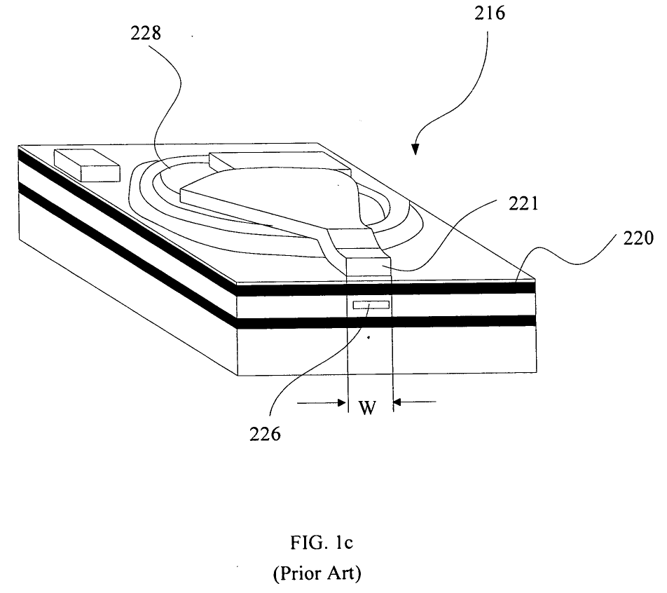

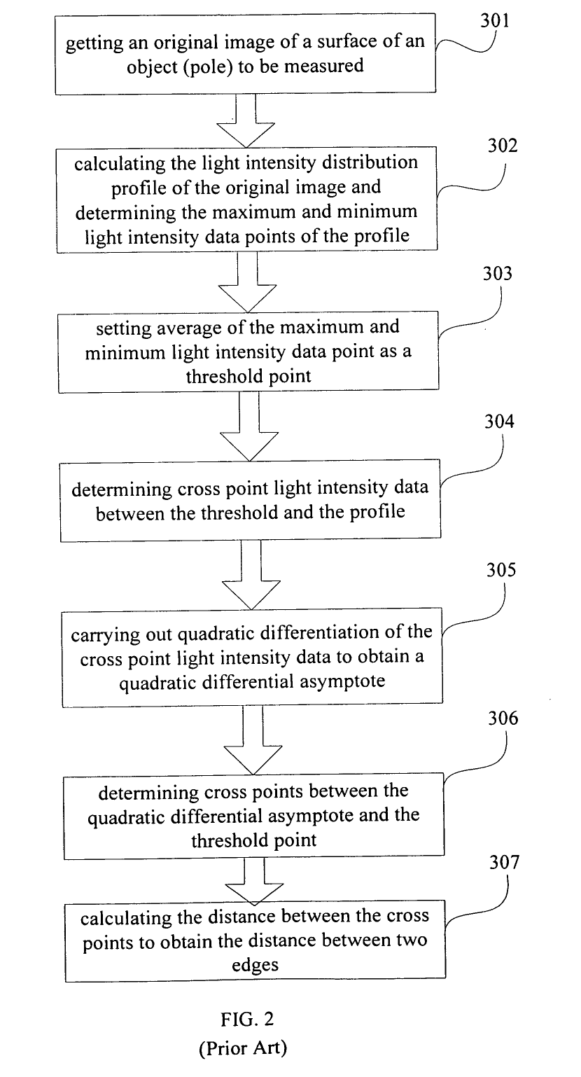

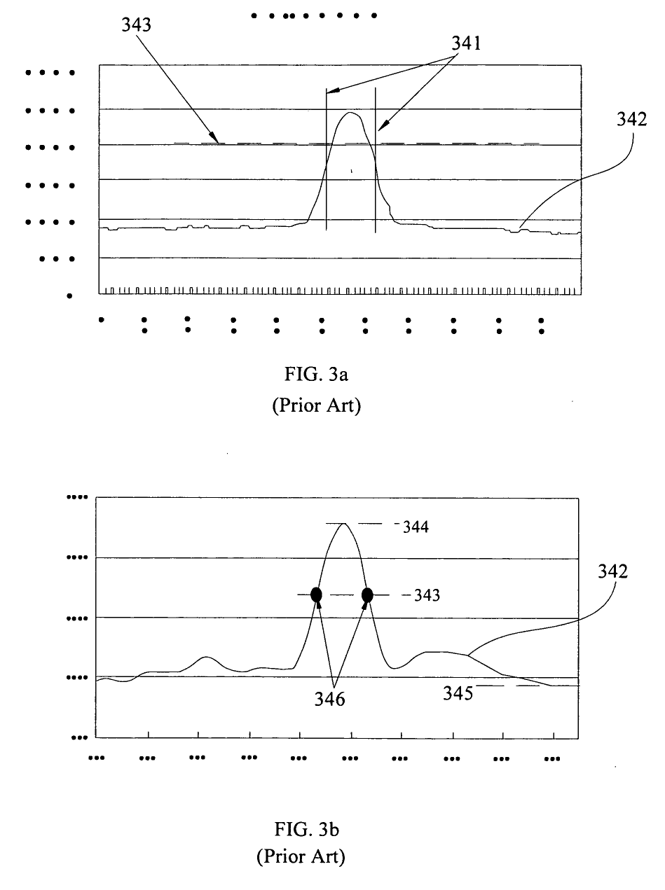

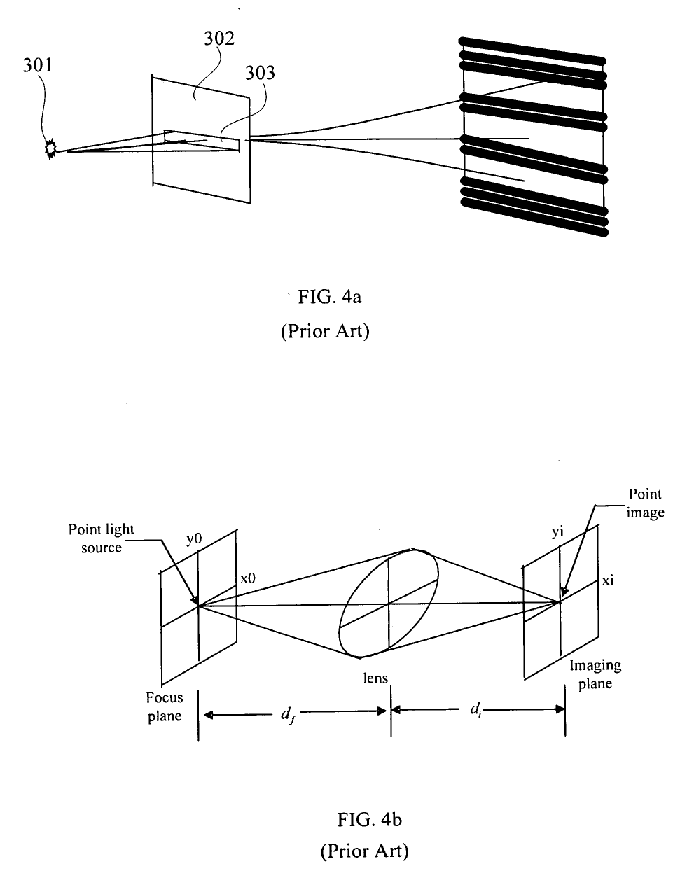

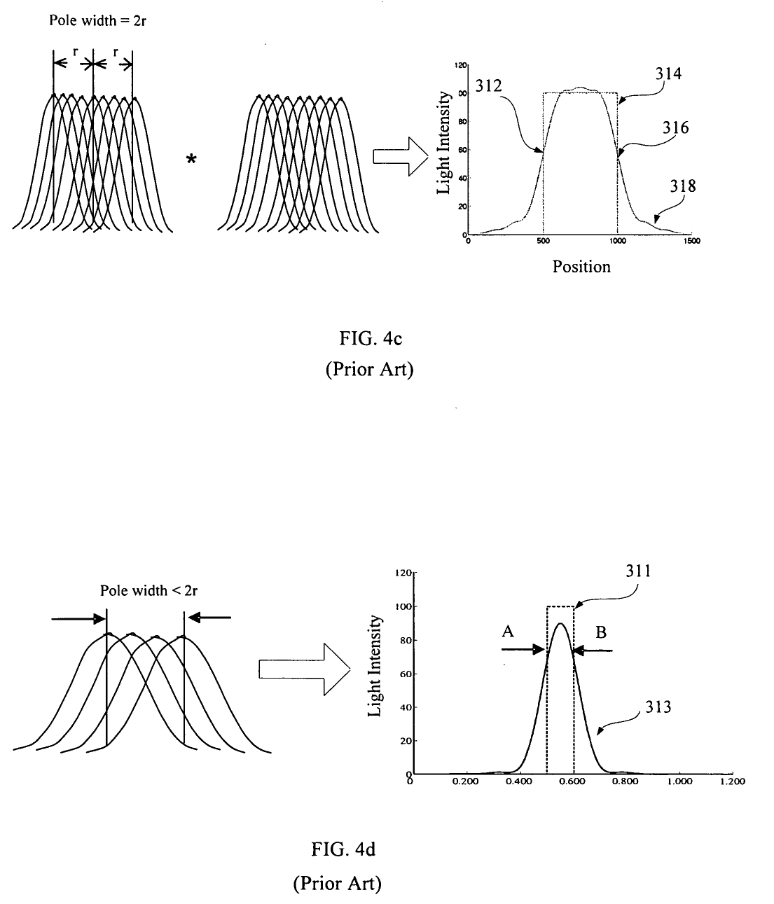

### DETAILED DESCRIPTION OF ILLUSTRATED EMBODIMENTS

Various preferred embodiments of the invention will now be described with reference to the figures. The invention provides a method for measuring pole width of a slider of a disk drive. The compensated pole width is obtained by compensating the initially measured pole width value. The compensation reduces or eliminates the bad effect of diffraction on the measure result during light transmission, thereby improving measuring accuracy of the pole width.

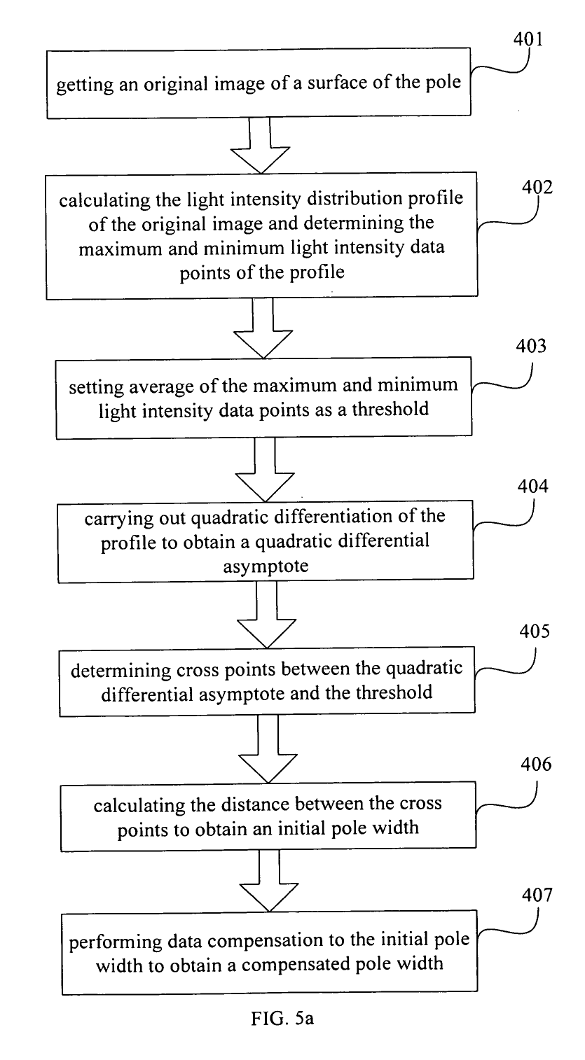

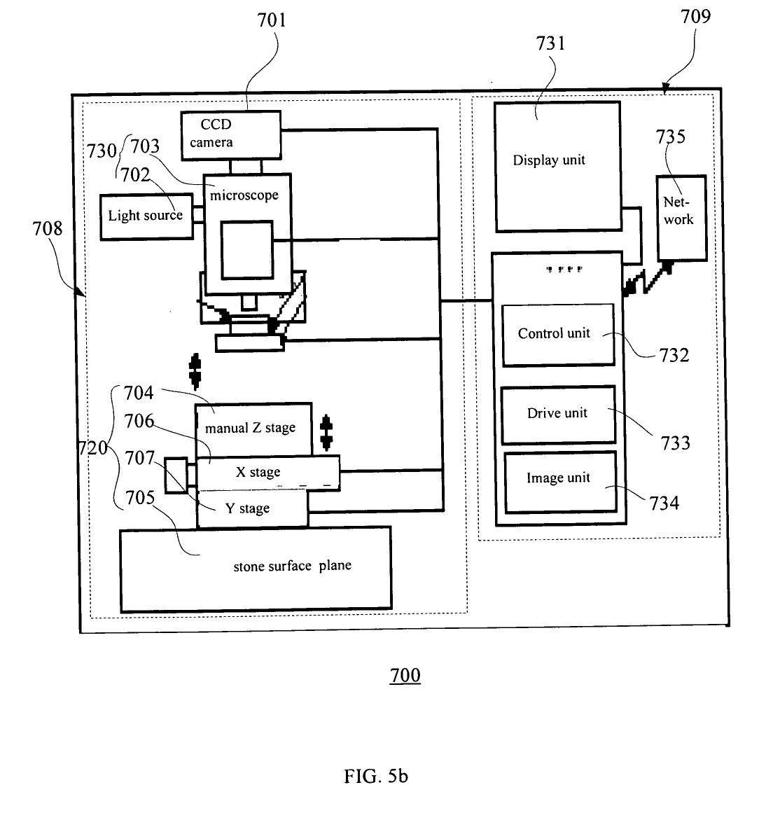

Referring to FIG. 5a, according to an embodiment of the present invention, a method for measuring pole width of a slider of a disk drive includes the following steps: getting an original image of a surface of the pole (Step 401); calculating the light intensity distribution profile of the original image and determining the maximum and minimum light intensity data points of the profile (Step 402); setting average of the maximum and minimum light intensity data points as a threshold (Step 403); carrying out quadratic differentiation of the profile to obtain a quadratic differential asymptote (Step 404); determining cross points between the quadratic differential asymptote and the threshold (Step 405); calculating the distance between the cross points to obtain an initial pole width (Step 406); performing data compensation to the initial pole width to obtain a compensated pole width (Step 407).

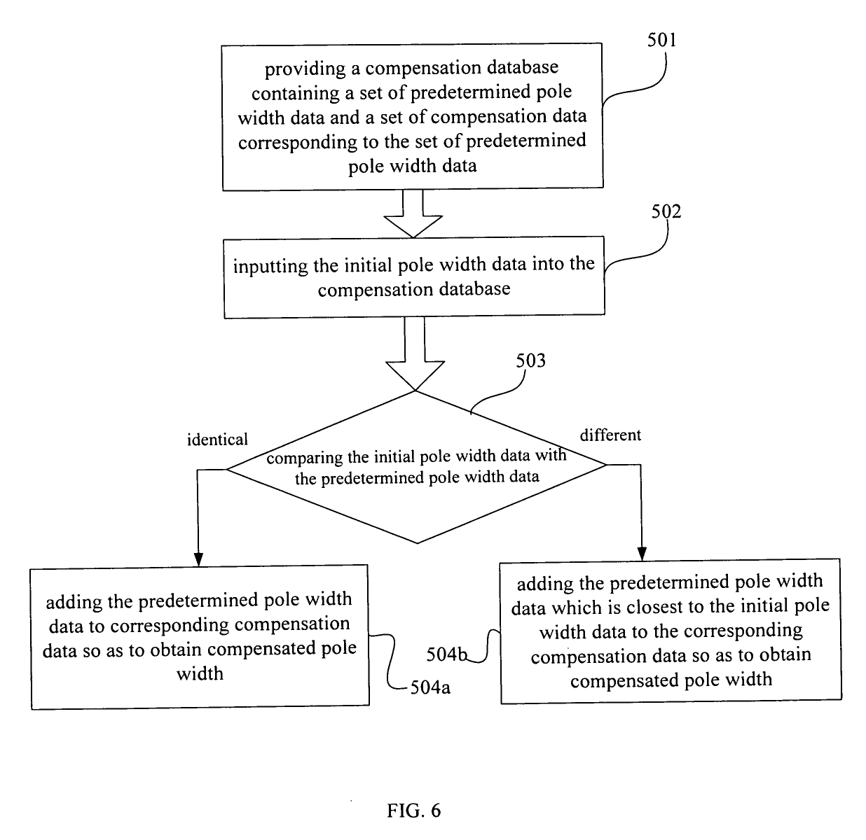

FIG. 6 illustrates the step 407 in greater detail. As is shown, firstly, a compensation database containing a set of predetermined pole width data and a set of compensation data corresponding to the set of predetermined pole width data is provided (Step 501). Then, the initial pole width data is input into the compensation database (Step 502). Next, the initial pole width data is compared with the predetermined pole width data (Step 503). If the data is identical, then the predetermined pole width data is added to the corresponding compensation data so as to obtain compensated pole width (step 504a); and if the data of the initial pole width and the data of the predetermined pole width are different, then the predetermined pole width data which is closest to the initial pole width data is added to the corresponding compensation data so as to obtain the compensated pole width (step 504b). Here, as light diffraction normally causes an initial pole width value bigger than the ideal pole width value, negative compensation to the initial pole width value is often performed, that is, the compensation data corresponding to the predetermined pole width data is negative value.

Furthermore, the step 401 may include: (i) getting a magnified image of the pole surface via an optical microscope system; and (ii) capturing the magnified image by a charge coupled device (CCD) camera. Concretely, as shown in FIG. 5b, the step of getting a magnified image of the pole surface via an optical microscope system and capturing the magnified image by a CCD camera can be implemented by a detection device 700 which includes a main unit 708 and a control unit 709 used to control the main unit 708. From the bottom to top, the main unit 708 includes in sequence a position moving subassembly 720 used to precisely control position of the object to be measured, an optical microscope subassembly 730 used to magnify image of the object surface to be measured and an image capturing subassembly 701 used to capture the magnified image.

The position moving subassembly 720 includes a X stage 706, a Y stage 707 and a manual Z stage 704, each of which can move freely and in a direction perpendicular to the rest stages. All of the stages are positioned on a stone surface plane 705. The stone surface plane 705 is supported by air, and accordingly, is also called air cushion platform. The air cushion platform guarantees the measuring precision and excludes some bad external influence, such as jolting and shaking. The optical microscope subassembly (optical microscope system) 730 includes a microscope 703 and a light source 702 which provides particular light to the microscope 703. The microscope 703 has two sets of lens magnification systems (not shown in the figures): a high magnification microscope (12000×) and a low magnification microscope (100×). A position from which a clear image of the object to be measured is shown in the low magnification microscope is set as an initial position, and then the high magnification microscope is employed to detect the image, and the image is then taken as an original enlarged image. It should be noted that the light source 702 may be any suitable light source. Preferably, the light source 702 is deep ultraviolet light with a wavelength of 248 nm. The image capturing subassembly 701 may be a CCD camera as shown in FIG. 6 and is used to pick up the magnified original image and save the image under the control of the control unit 709.

The control unit 709 is used to control the main unit 708 and includes a display unit 731, an operation unit 732, a drive unit 733, an image unit 734 and a network 735. In the method of the present invention, the control unit 709 can be a performing device that performs the steps after the original image is obtained, such as differential operation, compensation operation and so on.

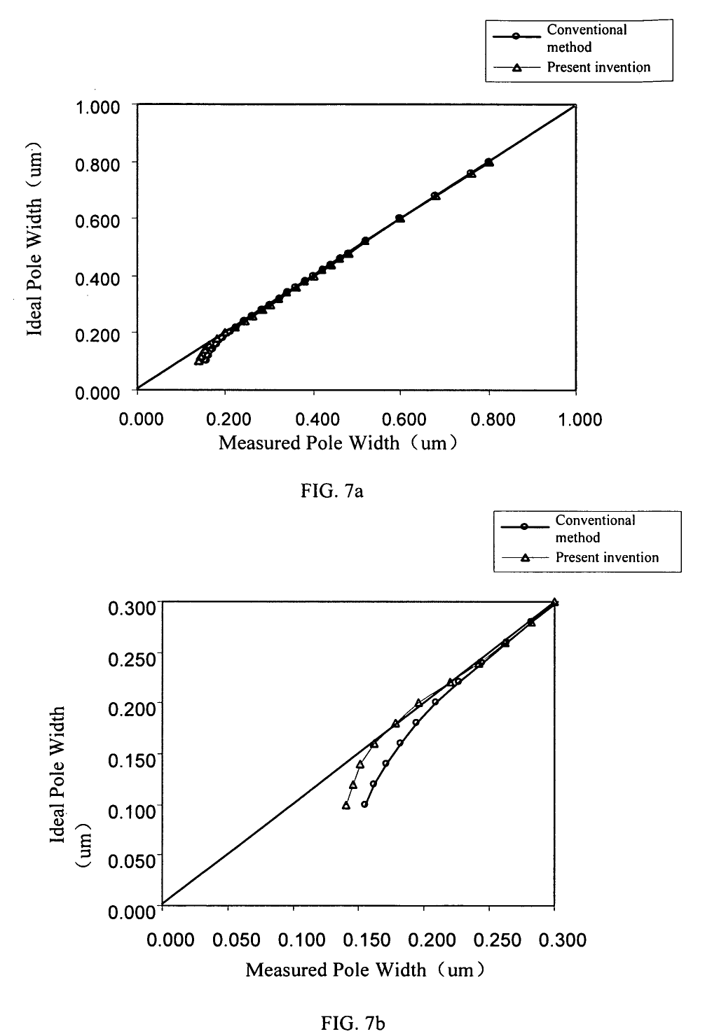

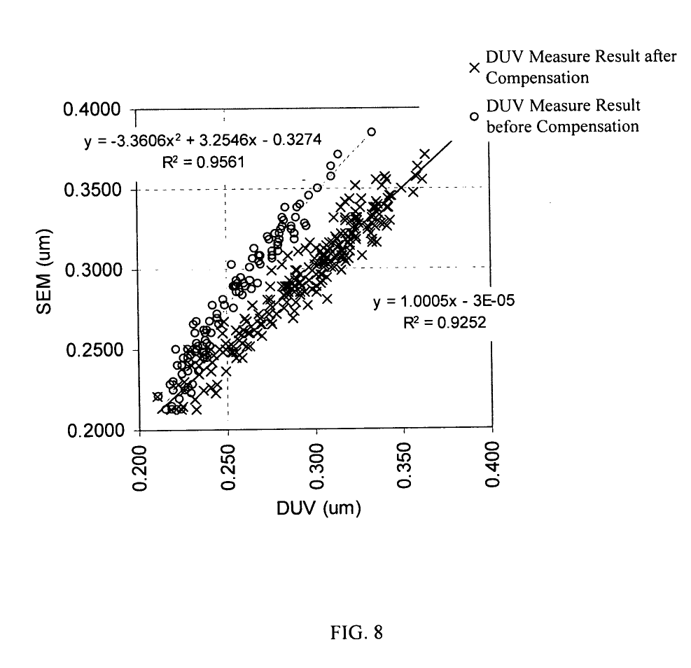

The effect of the method of the present invention is illustrated in combination with FIGS. 7a-7b and FIG. 8. FIG. 7a illustrates correlation curves of pole widths simulated by methods of the invention and prior art against ideal pole widths respectively. FIG. 7b shows an enlarged view of low end portions of the correlation curves shown in FIG. 7a. In the figures, the abscissa denotes the simulated pole width values (circle symbol denotes simulation values obtained from the conventional method, while triangle symbol denotes those obtained from the method of the present invention), and the ordinate denotes the ideal pole width values. It is clearly seen from the figures that the fitting curve constituted by the triangle symbols is closer to the ideal curve (the diagonal line) than the fitting curve constituted by the circle symbols. This indicates that the measure accuracy of the present method is higher than that of the conventional method. The smaller the pole width to be measured is, the more obviously the advantage of the invention can be seen, for example when the ideal pole width is between 0.1 um and 0.25 um, the accuracy difference is very clear. FIG. 8 shows correlation curves between pole widths achieved by DUV (deep ultraviolet device) and SEM (scanning electric microscope) before and after pole width compensation process. In this situation, since the SEM can obtain a very a high measuring accuracy, the data obtained by the SEM may be taken as standard test data for estimating the accuracy of other devices, such as DUV devices. It can be seen from the figure that the test data curve after compensation (represented by cross mark, namely the test data obtained by the method of the invention) is closer to the test data curve obtained by SEM (diagonal line in the figure) than the test dada curve before compensation (represented with circle mark, namely the test data of conventional method), that is to say, the invention can get higher measurement accuracy.

The present invention also provides a method for measuring the distance between edges of a micro-object. The method includes steps of: (1) getting an original image of a surface of the micro-object; (2) processing the original image to obtain an initial edge distance; and (3) performing data compensation to the initial edge distance to obtain a compensated edge distance.

The step (3) includes the following steps: (31) providing a compensation database containing a set of predetermined edge distance data and a set of compensation data corresponding to the set of predetermined edge distance data; (32) inputting the initial edge distance data into the compensation database; (33) comparing the initial edge distance data with the predetermined edge distance data, if the data is identical, then the predetermined edge distance data is added to the corresponding compensation data so as to obtain compensated edge distance (34a); and if the data of the initial edge distance and the data of the predetermined edge distance are different, then the predetermined edge distance data which is closest to the initial edge distance data is added to the corresponding compensation data so as to obtain the compensated edge distance (34b).

The compensation data corresponding to the predetermined edge distance data is negative data. The step (1) may include: (a) getting a magnified image of the micro-object's surface by an optical microscope; and (b) capturing the magnified image by a charge coupled device camera.

The foregoing description of the present invention has been presented for purposes of illustration and description. It is not intended to be exhaustive or limit the invention to the accuracy form disclosed, and obviously many modifications and variations are possible in light of the above teaching. Such modifications and variations that may be apparent to those skilled in the art are intended to be included within the scope of this invention as defined by the accompanying claims.

What is claimed is:

1. A method for measuring pole width of a slider of a disk drive comprising the steps of:
(1) getting an original image of a surface of the pole;
(2) calculating the light intensity distribution profile of the original image and determining the maximum and minimum light intensity data points of the profile;
(3) setting average of the maximum and minimum light intensity data points as a threshold;
(4) carrying out quadratic differentiation of the profile to obtain a quadratic differential asymptote;
(5) determining cross points between the quadratic differential asymptote and the threshold;
(6) calculating the distance between the cross points to obtain an initial pole width; and
(7) performing data compensation to the initial pole width to obtain a compensated pole width.

2. The method as claimed in claim 1, wherein the step (7) comprises steps of:
(71) providing a compensation database containing a set of predetermined pole width data and a set of compensation data corresponding to the set of predetermined pole width data;
(72) inputting the initial pole width data into the compensation database; and
(73) comparing the initial pole width data with the predetermined pole width data, if the data is identical, then performing step (74a): adding the predetermined pole width data to the corresponding compensation data so as to obtain compensated pole width; and if the data is different, then performing step (74b): adding the predetermined pole width data which is closest to the initial pole width data to the corresponding compensation data so as to obtain the compensated pole width.

3. The method as claimed in claim 2, wherein the compensation data corresponding to the predetermined pole width data is negative data.

4. The method as claimed in claim 1, wherein the step (1) comprises: (a) getting a magnified image of the pole surface by an optical microscope system; and (b) capturing the magnified image by a charge coupled device camera.

5. The method as claimed in claim 4, wherein the optical microscope system includes two sets of lens microscope system.

6. The method as claimed in claim 4, wherein the optical microscope system uses deep ultraviolet light with a wavelength of 248 nm as its light source.

7. A method for measuring the distance between edges of a micro-object, comprising the steps of:
(1) getting an original image of a surface of the micro-object;
(2) processing the original image to obtain an initial edge distance; and
(3) performing data compensation to the initial edge distance to obtain a compensated edge distance.

8. The method as claimed in claim 7, wherein the step (3) comprises steps of:
(31) providing a compensation database containing a set of predetermined edge distance data and a set of compensation data corresponding to the set of predetermined edge distance data;
(32) inputting the initial edge distance data into the compensation database; and
(33) comparing the initial edge distance data with the predetermined edge distance data, if the data is identical, then the predetermined edge distance data is added to the corresponding compensation data so as to obtain compensated edge distance (34a); and if the data of the initial edge distance and the data of the predetermined edge distance are different, then the predetermined edge distance data which is closest to the initial edge distance data is added to the corresponding compensation data so as to obtain the compensated edge distance (34b).

9. The method as claimed in claim 8, wherein the compensation data corresponding to the predetermined edge distance data is negative data.

10. The method as claimed in claim 7, wherein the step (1) comprises: (a) getting a magnified image of the surface of the micro-object by an optical microscope system; and (b) capturing the magnified image by a charge coupled device camera.
